(19) United States
(12) Patent Application Publication
(10) Pub. No.: US 2026/0065701 A1
(43) Pub. Date: Mar. 5, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: KENICHI SHIRAISHI, Kanagawa (JP)

(21) Appl. No.: 19/311,620

(22) Filed: Aug. 27, 2025

(30) Foreign Application Priority Data
Sep. 4, 2024 (JP) 2024-152248

(51) Int. Cl. G06V 30/14; G06V 30/19; H04N 1/00

(52) U.S. Cl. CPC G06V 30/1448; G06V 30/1456; G06V 30/19; H04N 1/00244; H04N 1/00331; H04N 1/00408; H04N 2201/0094

(57) ABSTRACT

An information processing apparatus: detects, from a document image obtained by reading a marked document, a marked region; displays a first setting screen for setting a process to be associated with the detected marked region based on designation by a user; and executes the process set on the first setting screen on the detected marked region.

### BACKGROUND

### Field of the Technology

The present disclosure relates to an information processing apparatus, an information processing method, and a storage medium.

### Description of the Related Art

There is a technique in which a character string extracted from a specific region of a document image obtained by scanning a document that has been marked by a user with a marker pen by filling in the region is used as the file name of the document image or the like.

Japanese Patent Laid-Open No. 2022-140208 discloses a technique in which a specific process is associated with each of individual colors that may be used for marking, and specific regions of a document image that have been marked are subjected to the corresponding specific processes.

### SUMMARY

An information processing apparatus according to an aspect of the technique of the present disclosure includes: at least one memory that stores instructions; and at least one processor that executes the instructions to: detect, from a document image obtained by reading a marked document, a marked region; display a first setting screen for setting a process to be associated with the detected marked region based on designation by a user; and execute the process set on the first setting screen on the detected marked region.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of a system.

FIG. 2 is a diagram illustrating an example of hardware configurations of information processing apparatuses.

FIG. 3 is a diagram illustrating an example of software configurations of apparatuses forming the system.

FIG. 4 is a diagram for describing a marked form.

FIG. 5 is a diagram illustrating an example of a screen for setting marking and processes to be executed.

FIG. 6 is a flowchart illustrating a flow of form processing according to a comparative example.

FIGS. 7A to 7D are an example of display screens.

FIGS. 8A to 8C are diagrams illustrating an example of setting screens for form processing.

FIG. 9 is a diagram illustrating an example of a form setting screen including unexecutable processes.

FIG. 10 is a diagram showing the relationship of FIG. 10A and FIG. 10B.

FIGS. 10A and 10B are flowcharts illustrating a flow of the form processing.

FIG. 11 is a diagram showing the relationship between FIG. 11A through FIG. 11D.

FIGS. 11A to 11D are flowcharts illustrating a flow of form processing using learning information.

FIGS. 12A and 12B are diagrams illustrating an example of setting screens for the form processing using learning information.

### DESCRIPTION OF THE EMBODIMENTS

An embodiment of the technique of the present disclosure will be described below in detail with reference to the drawings. It is to be noted that this embodiment does not limit the technique of the present disclosure according to the claims. Not all of the features described in the embodiment are necessarily essential for the solution to be provided by the technique of the present disclosure, and multiple features may be combined in any ways. Note that identical components will be described with the same reference sign given thereto. Also, each of the processes (steps) in the flowcharts is denoted with a prefix “S.”

### First Embodiment

### System Configuration

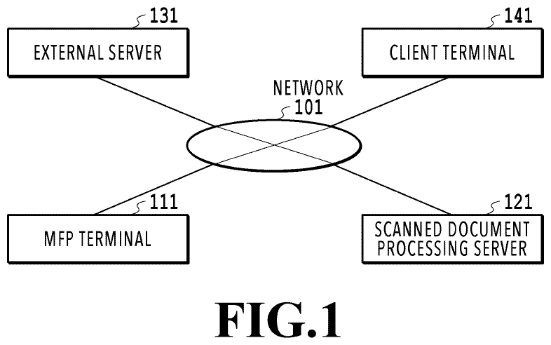

FIG. 1 is a diagram illustrating an example of a configuration of an image processing system according to the present embodiment. The image processing system in the present embodiment has a multi function peripheral (MFP) terminal 111, a scanned document processing server 121, an external server 131, and a client terminal 141. These apparatuses are connected to one another through a network 101, such as the Internet or an intranet.

The MFP terminal 111 is a multi function peripheral that has multiple functions, such as a scanner function and a printer function, and performs image forming and various processes, for example.

The scanned document processing server 121 is a server apparatus that receives scanned image data of a document obtained by scanning of the document by the MFP terminal 111 along with a processing request, and performs the requested image processing on the scanned image data of the document. Further, the scanned document processing server 121 is a server apparatus that provides services with functions that collaborate with the MFP terminal 111 and the external server 131, such as transmitting the scanned image data of the document subjected to the image processing to a file storage destination, such as the external server 131, and the like. The scanned document processing server 121 has various functions, e.g., a function to manage setting information according to the collaborating external server and MFP terminal and user information, a function to perform image processing on scanned image data of documents, and so on. Note that the configuration may be such that multiple different servers are separately equipped with these functions, and the multiple servers collaborate with one another.

The external server 131 is a server apparatus that provides a cloud storage service for storing scanned image data of documents, for example. Note that the external server 131 is not limited to this and may be a server apparatus that also provides another external service that executes a workflow of tasks, such as registering, updating, and executing work data based on information extracted from the scanned image data of a document. Also, the description will be given on the assumption that the external server 131 is provided as a web application, but the external server 131 may be in an on-premises form implemented within a server environment inside an office's intranet.

The client terminal 141 is an apparatus, such as a computer, a tablet, or a smartphone, capable of displaying web user interfaces (UIs) provided by the scanned document processing server 121 and the external server 131 with an application, such as a browser, installed in the client terminal.

### Hardware Configuration of Information Processing Apparatus

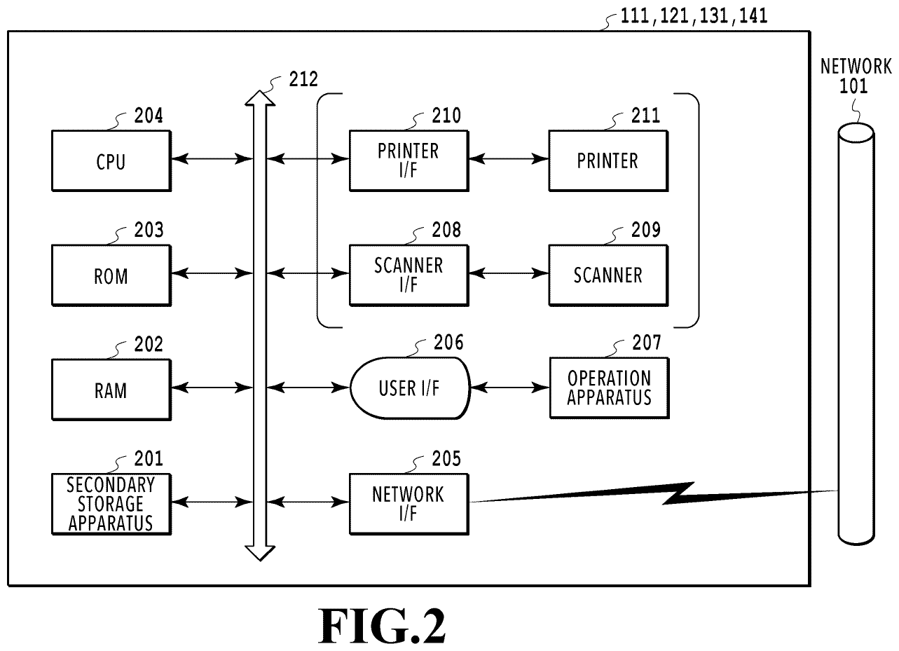

FIG. 2 is a block diagram illustrating hardware configurations of the MFP terminal 111, the scanned document processing server 121, the external server 131, and the client terminal 141 as information processing apparatuses.

Each of the information processing apparatuses has a secondary storage apparatus 201, a random-access memory (RAM) 202, a read-only memory (ROM) 203, a central processing unit (CPU) 204, a network interface (hereinafter referred to as “network I/F”) 205, a user interface (hereinafter referred to as “user I/F”) 206, and an operation apparatus 207. Of the information processing apparatuses, the MFP terminal 111 further has a scanner interface (hereinafter referred to as “scanner I/F”) 208, a scanner 209, a printer interface (hereinafter referred to as “printer I/F”) 210, and a printer 211. Each of the information processing apparatuses has a system bus 212 to which devices are connected, and is configured to be capable of exchanging data between them through the system bus 212.

The secondary storage apparatus 201 is a secondary storage apparatus as represented by a hard disk drive (HDD) or a flash memory. The RAM 202 has a temporary memory area. The ROM 203 stores embedded programs and data. The CPU 204 loads programs read out from the secondary storage apparatus 201, the RAM 202, the ROM 203, and the like into the RAM 202 and execute them.

The network I/F 205 connects to a network, such as a local area network (LAN), and communicates with other computers, MFPs, printers, network devices, and external services. The communication method may be wired or wireless.

The user I/F 206 controls input and output from the operation apparatus 207, which a display, a keyboard, a mouse, buttons, a touch panel, and the like. Computers that do not include these pieces of hardware can be connected from another computer and operated with it by remote desktop, remote shell, or the like.

The scanner I/F 208 controls input and output into and from the scanner 209. The printer I/F 210 controls input and output into and from the printer 211.

### Software Configuration

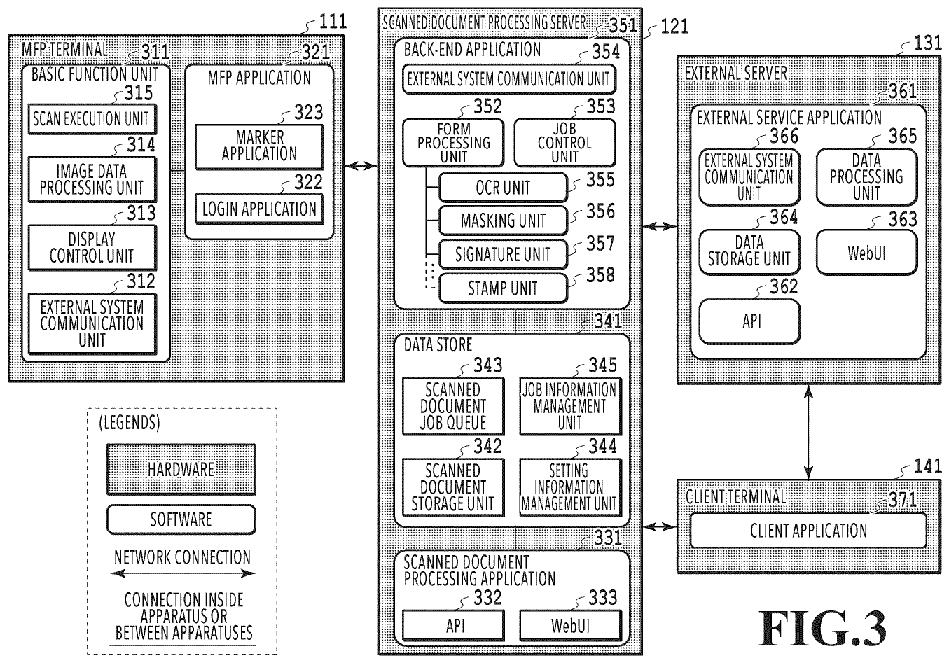

FIG. 3 is a diagram illustrating an example of software configurations of the apparatuses forming the image processing system according to the present embodiment. Pieces of software installed in the MFP terminal 111, the scanned document processing server 121, the external server 131, and the client terminal 141 are executed by the respective CPUs 204 to implement predetermined functions. Note that the MFP terminal 111, the scanned document processing server 121, the external server 131, and the client terminal 141 are configured to be capable of communicating with one another as illustrated with the arrows indicating network connections.

### Software Configuration of MFP Terminal 111

The MFP terminal 111 is broadly divided into two parts: a basic function unit 311 and an MFP application 321. The basic function unit 311 is a set of standard functions included in the MFP terminal 111. The MFP application 321 is a set of applications additionally installed in the MFP terminal 111. The MFP application 321 is a set of applications based on Java (registered trademark), which enable functions to be easily added to the MFP terminal 111. To simplify the description, the present embodiment will be described on the assumption that a login application 322 and a marker application 323 are installed as the MFP application 321, but is not limited to this. For example, a configuration in which these functions are implemented in the form of a single bundled application may be employed. A configuration in which these functions separately are installed and linked and are implemented by many applications may be employed.

The basic function unit 311 has an external system communication unit 312, a display control unit 313, an image data processing unit 314, and a scan execution unit 315.

The external system communication unit 312 requests the scanned document processing server 121 to perform various processes and analyzes the results of those processes given as responses. For example, the external system communication unit 312 issues processing requests, such as a login request, a request to perform a process on a scanned image, and a request to obtain and execute a process on information held by the external server 131, to the scanned document processing server 121 serving as a relaying server. A protocol such as Representational State Transfer (REST), Simple Object Access Protocol (SOAP), or the like is used for the communication with the scanned document processing server 121, but other communication means may be used.

The display control unit 313 controls display of UI screens for accepting user operations with the operation apparatus 207 through the user I/F 206 of the MFP terminal 111, and input and output into and from that UI screen. For example, the display control unit 313 accepts input of authentication information for logging into the device, and operations for configuring scan settings and executing a scan. Also, the display control unit 313 displays UI screens, such as a preview screen, and accepts input into those screens.

The image data processing unit 314 executes image processing supported by the MFP terminal 111 on scanned image data received from the scan execution unit 315 and saves the scanned image data subjected to the image processing to the secondary storage apparatus 201. Also, the image data processing unit 314 obtains the saved scanned image data subjected to the image processing from the secondary storage apparatus 201 upon request.

In response to receiving a scan request including scan setting information, the scan execution unit 315 reads a document placed on a platen glass or a feeder with the scanner 209 through the scanner I/F 208 in accordance with that request to generate scanned image data of the document. The generated scanned image data of the document is transferred to the image data processing unit 314. The scanned image data of the document is an image file in a Joint Photographic Experts Group (JPEG) format or another format or a document file in a Portable Document Format (PDF) format or another format. The scan execution unit 315 returns a scanned image identifier uniquely indicating the saved scanned image data of the document to the scan request source. The scanned image identifier is a number, a symbol, an alphabetical character, or the like (not illustrated) uniquely identifying the document image obtained by the scan by the MFP terminal 111.

The login application 322 associates authentication information of the MFP terminal 111 and authentication information of the scanned document processing server 121 with each other and executes a login by any means or method, such as an ID, a user name, a password, a PIN code, or card touch. Upon a successful login, it becomes possible to operate various functions of the MFP terminal 111 and obtain necessary information, such as user information application settings, and scan settings, managed by the scanned document processing server 121.

The marker application 323 is an application, and presents a scan screen or a screen for configuring scan settings to the user through the display control unit 313, and executes a scan based on the set contents using the scan execution unit 315 of the basic function unit 311. The marker application 323 obtains the scanned image data corresponding to a scanned image identifier received from the scan execution unit 315 out of the secondary storage apparatus 201 by means of the image data processing unit 314. The marker application 323 presents a screen for setting the contents of a process to be executed on the scanned image data to the user through the display control unit 313. The marker application 323 issues requests to obtain the obtained scanned image data, the contents of the process to be executed on the scanned image data, and information held by the external server 131 that is necessary for displaying them to the scanned document processing server 121 through the external system communication unit 312. User information used at the times of issuing these requests is information based on the user information used to log in with the login application 322. The marker application 323 analyzes responses and displays a scan screen, setting screens, and a process result screen.

### Software Configuration of Scanned Document Processing Server 121

A scanned document processing application 331 is a web application provided by the scanned document processing server 121, and transmits image processing for scanned image data of documents obtained by the MFP terminal 111 and the scanned image data of the documents to the external server 131. The present embodiment will be described on the assumption that the scanned document processing application 331 operates as a web application, but may be implemented as another application. The scanned document processing application 331 has an application programming interface (API) 332 and a web UI 333.

The API 332 is an application programming interface provided by the scanned document processing application 331. The web UI 333 is a user interface for setting applications and servers from a web browser provided by the scanned document processing application 331.

A data store 341 is a storage area for saving and storing data to be used by the scanned document processing application 331 or a back-end application 351 to be described later. The data store 341 stores various data for a scanned document storage unit 342, a scanned document job queue 343, a setting information management unit 344, and a job information management unit 345.

The scanned document storage unit 342 stores scanned image data received by an external system communication unit 354 to be described later from the MFP terminal 111 in the scanned document processing server 121.

The scanned document job queue 343 holds a queue for managing jobs waiting to be processed. A “job” is a unit of execution for processing a scanned document requested by the MFP terminal 111. While the description will be given of a case with a single queue to simplify the description, multiple queues may be provided according to the scheduling priorities or the processing contents of the jobs.

The setting information management unit 344 manages setting information to be used during scanning. Also, the setting information management unit 344 manages pieces of user information that are needed for the collaboration between the MFP terminal 111 and the scanned document processing server 121 and the collaboration between the scanned document processing server 121 and the external server 131 in association with the MFP terminal, the external server, and the user. The setting information management unit 344 also manages processing information corresponding to marking to be described later in association with pieces of user information and form types. Additionally, the setting information management unit 344 also manages settings of the whole scanned document processing server. To simplify the description, the management of various settings is done by a single setting information management unit 344 but a configuration in which the management of various settings is divided based on the type of information to be managed may be employed.

The job information management unit 345 manages detailed information on jobs on a job-by-job basis, such as each job's processing status and date and time of registration, setting information at the time when an instruction to execute the job was issued, and so on.

The back-end application 351 is responsible for background processing and includes a form processing unit 352, a job control unit (status management unit) 353, and the external system communication unit 354.

The form processing unit 352 executes form processing on data of scanned images or captured images. In the present embodiment, the form processing unit 352 extracts marker regions of documents marked with marker pens, such as highlighters, of given colors for confirmation or instruction, and executes processes on the extracted regions. Examples of the processes to be executed on the extracted regions include a character recognition process by an optical character recognition (OCR) unit 355, a masking process by a masking unit 356, a signature process by a signature unit 357, a stamp process by a stamp unit 358, and so on. The present embodiment will be described on the assumption that the processing components included in the form processing unit 352 execute the form processing. Incidentally, a configuration which uses the basic functions of the image data processing unit 314 of the MFP terminal 111 and functions added to the MFP application 321 may be employed. Alternatively, a configuration in which a separate image processing system or server that collaborates with the scanned document processing server 121 may be prepared and utilized in collaboration with the scanned document processing server 121 may be employed.

Additionally, the form processing unit 352 obtains input images from the scanned document storage unit 342 and executes OCR, compression, division, and conversion on the whole documents as general form processing. Furthermore, the form processing unit 352 executes a form determination process as represented by pattern recognition and machine learning, page extraction, rotation deletion of specific pages, and insertion of pages, and the like.

In the back-end application 351, the job control unit 353 confirms the status of each job or the processing statuses of the scanned document processing server 121 and the external server (work server) 131, and executes processing according to the statuses.

The external system communication unit 354 executes processes for receiving scanned image data and requests for various processes transmitted from the MFP terminal 111 and transmitting the results of those processes as responses, and processes for transmitting requests for various processes to and receiving the results of those processes as responses from the external server 131. A protocol such as REST, SOAP, or the like is used for the communication with the MFP application 321 and the external server 131, but other communication means may be used. Examples of the various processes which the external server 131 is requested to execute include obtaining of a request for authentication to be executed from the MFP terminal 111 through the scanned document processing server 121, obtaining of a request for processing of scanned image data, obtaining of various information managed by the external server 131, and so on.

The external server 131 executes an external service application 361 which is an external service's web application. The external service application 361 has an API 362, a web UI 363, a data storage unit 364, a data processing unit 365, and an external system communication unit 366.

The API 362 is provided by the external service application 361. The web UI 363 is provided by the external service application 361. The data storage unit 364 stores data to be used by the external service application 361.

The data processing unit 365 executes processes requested by the MFP terminal 111 and the scanned document processing server 121. The external system communication unit 366 executes processes for reception and transmission, such as analyzing requests received from the MFP terminal 111 and the scanned document processing server 121 and transmitting process results as responses.

To simplify the description, the form and configuration of the external server 131 are consolidated into a single application, but the form and configuration of the external server 131 is not limited to this. As with the scanned document processing server 121, the external server 131 may be provided in a form and configuration in which the system and application are divided on a function-by-function basis into a back-end application, a data store, and so on.

Assume that there is one or more external server 131 that collaborate with the scanned document processing server 121 for the purpose of transmitting, processing, storing, or executing the results of processes by the MFP terminal 111 and the scanned document processing server 121.

The client terminal 141 executes a client application 371. The client application 371 is a browser that runs on the client terminal 141. The client application 371 displays web UIs provided by the scanned document processing application 331 and the external service application 361 and allows browsing and editing of settings. A configuration in which the client application 371 is provided using desktop applications in an exe format or another format provided by respective services may be employed.

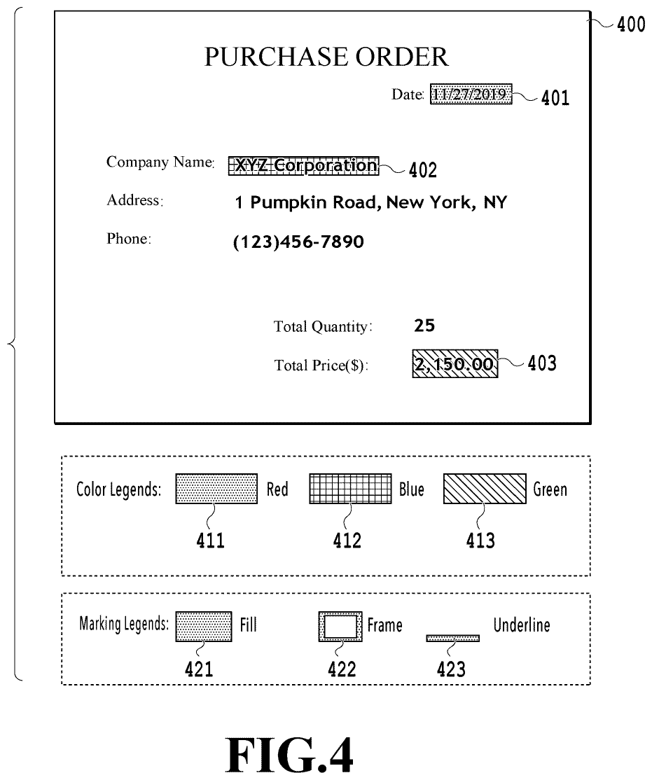

A problem that occurs in a comparative example will now be described using FIGS. 4 to 6.

FIG. 4 is a diagram illustrating an example of a form which is a marked document marked with marker pens, such as highlighters.

A form 400 which has been marked by the user has regions 401, 402, and 403 marked with the marker pens. The region 401 is a region marked in red 411. The region 402 is a region marked in blue 412. The region 403 is a region marked in green 413. The marking method includes filling 421, framing 422, and underlining 423, for example. The filling 421 represents a region being a predetermined region the entirety of which is colored with a marker. The framing 422 represents a frame around a predetermined region colored with a marker. The underlining 423 represents a region under a predetermined region colored with a marker. Note that the marking method is not limited to these. For example, in a case where character string regions in the form can be determined by a form analysis, any analysis means and markings may be combined, such as using check marks or black dots as an instruction to read the closest character string regions to them.

### Setting Screen for Form Processing

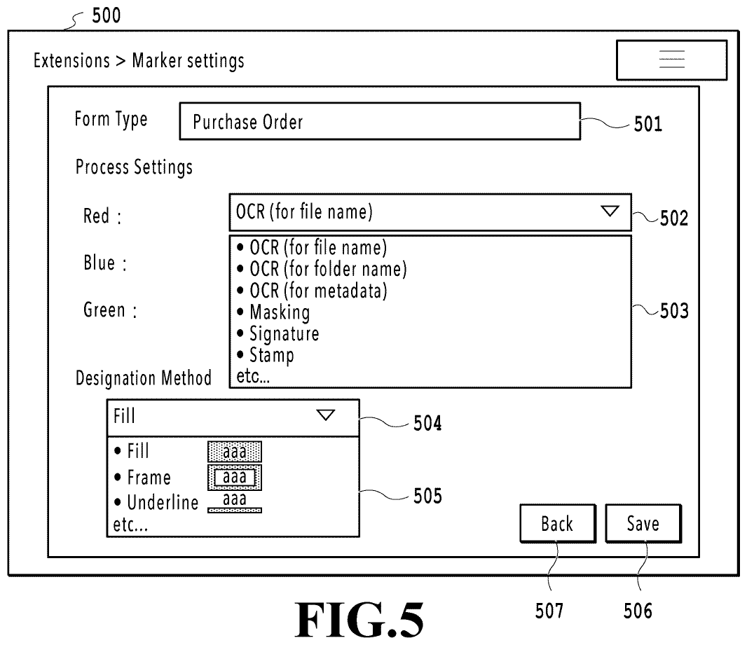

FIG. 5 is a diagram illustrating an example of a UI screen for setting processes to be associated with respective colors and a marking designation method in form processing. Note that FIG. 5 illustrates a state where “Purchase Order” is input in an input region 501, OCR (for file name) is selected in a process setting field 502 for red, and filling is selected in a designation method field 504.

A setting screen 500 for form processing is a UI screen for setting processes to be associated with marker colors. With the configuration in FIG. 3, the setting screen 500 is displayed on the client application 371 by the web UI 333 provided by the scanned document processing application 331. On the setting screen 500, the contents of marking processes associated with a user and a form stored in the data store 341 can be edited. The setting screen 500 has the setting name input region 501, the process setting field 502, and the designation method field 504. Also, the setting screen 500 has a save button 506 and a back button 507.

The setting name input region 501 is a region that accepts input of a setting name for managing the setting information. It is desirable to manage the setting information with the name of the form type so that the form type, settings, and the contents of the processes can be identified.

The process setting field 502 is afield for setting which process to associate with a marking color. In the process setting field 502, a process can be selected from a pull-down menu 503. For example, one of options such as OCR (for file name), OCR (for folder name), OCR (for metadata), masking, signature, stamp, and so on can be selected.

The designation method field 504 is a field for designating a method of marking with markers. In the designation method field 504 too, a designation method can be selected from a pull-down menu 505, as with the process setting field 502. For example, one of options such as filling, framing, underlining, and so on can be selected.

The save button 506 saves the settings designated on the setting screen 500 in response to being pressed by a user operation. In the example of FIG. 5, the setting “OCR (for file name)” for red and the setting “Filling” as a designation method are saved as the process settings. The back button 507 cancels the settings on the setting screen 500 and switches the setting screen 500 to the display screen displayed before it in response to being pressed by a user operation.

### Form Processing According to Comparative Example

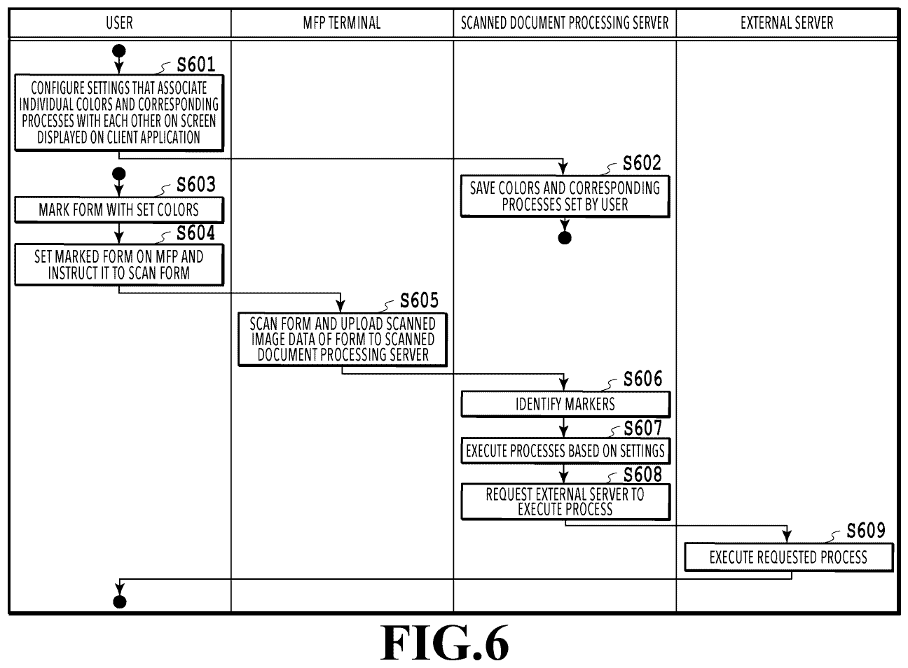

FIG. 6 is a flowchart illustrating a flow of form processing executed by the system according to the comparative example. Note that FIG. 6 illustrates the flow of the processing divided by the user, the MFP terminal, the scanned document processing server, and the external server as actors. In order to describe a problem with the processing in the comparative example, processes that are not necessary for the description of the problem, such as login, for example, are not illustrated, and details thereof will be described later.

In S601, the user firstly configures settings which associate individual colors and corresponding processes with each other on a setting screen as illustrated in FIG. 5 displayed on the client application 371 for setting which process to execute in a case where a given color is used for marking.

In S602, the scanned document processing server 121 saves the colors and the contents of the corresponding processes set by the user to the setting information management unit 344. By the processes in S601 and S602, setting information is registered in the scanned document processing server in advance.

In S603, following the settings configured in S601 and S602, the user marks a form to be scanned and subjected to a predetermined process with marker pens of the corresponding colors by the designated method.

In S604, the user sets the marked form on the MFP terminal 111 and instructs it to scan the form.

In S605, the MFP terminal 111 scans the set form, which is a document, to obtain scanned image data of the form (document). The MFP terminal 111 uploads the obtained scanned image data of the form to the scanned document processing server 121 through the external system communication units 312 and 354.

In S606, the scanned document processing server 121 stores the uploaded scanned image data of the form in the scanned document storage unit 342, stacks it in the scanned document job queue 343, and detects the marked regions with the form processing unit 352.

This detection of the marked regions is generally done by defining a threshold value for each parameter of a color space, such as an RGB space, an HSV space, or a HSL space, and identifying regions with color information present within that range. Note that the detection target colors, such as blue, red, green, and yellow, are set in advance. Also, the threshold value for each color is set in advance as well.

In S607, the form processing unit 352 obtains the processes corresponding the colors of the detected regions from the setting information management unit 344, and executes the processes associated with the colors.

For example, in a case where OCR (for file name) is designated, the form processing unit 352 passes information on the original image and the corresponding region to a component with an OCR function to extract and hold the character string in the region, and will use it as a parameter of a request when saving the scanned document to the external server 131. In a case where OCR (for folder name) or OCR (for metadata) is designated too, similar processing to that with OCR (for file name) is performed, and detailed description thereof is omitted. In a case where masking is designated, the form processing unit 352 passes information on the original image and the corresponding region or regions to a component with a masking function to perform masking on the region or regions. In a case where signature is designated, the form processing unit 352 passes information on the original image and the name to be provided in the corresponding region to a component with a signature function to provide the name in the region, and will use it as a parameter of a request when saving the scanned document to the external server 131. In a case where stamp is designated, the form processing unit 352 passes information on the original image and the character string to be provided in the corresponding region to a component with a stamp function to provide the character string in the region and will use it as a parameter of a request when saving the scanned document to the external server 131.

In S608, after the form processing unit 352 completes the designated form processing, the scanned document processing server 121 requests a process to be executed by the external server 131. For example, in a case where the external server 131 is a cloud storage, the scanned document processing server 121 issues a request to save the scanned document.

In S609, the external server 131 executes the requested process through the external system communication units 354 and 366.

The above has described a series of processes in which a form marked with marker pens by a user is subjected to processes corresponding to the contents of the marking has been described above.

With the method described using FIGS. 4 to 6, however, pieces of information indicating predefined processes associated with colors that may be used for marking are stored in advance and, in a situation where the user performs marking, the user needs to follow the stored information to change the marker pen color to use, which is troublesome. In particular, increasing the number of types of colors that may be used for marking increases the number of combinations of a color and a process, which may impose a greater burden on the user for remembering the combinations and changing the combination to use.

In view of this, in the present embodiment, a preview display method will be described which, after a marked document is read, allows the user to set any processes as the processes to be performed on the marked regions on the device without becoming conscious about the colors used for the marking and the processes for them. Also, a method will additionally be described which involves learning the set processes to facilitate the configuring of settings in the next and subsequent occasions.

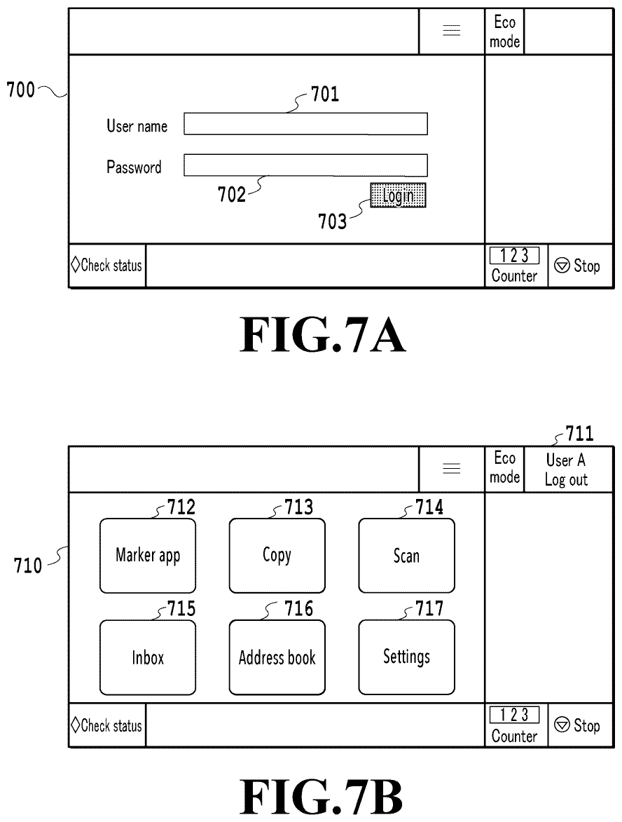

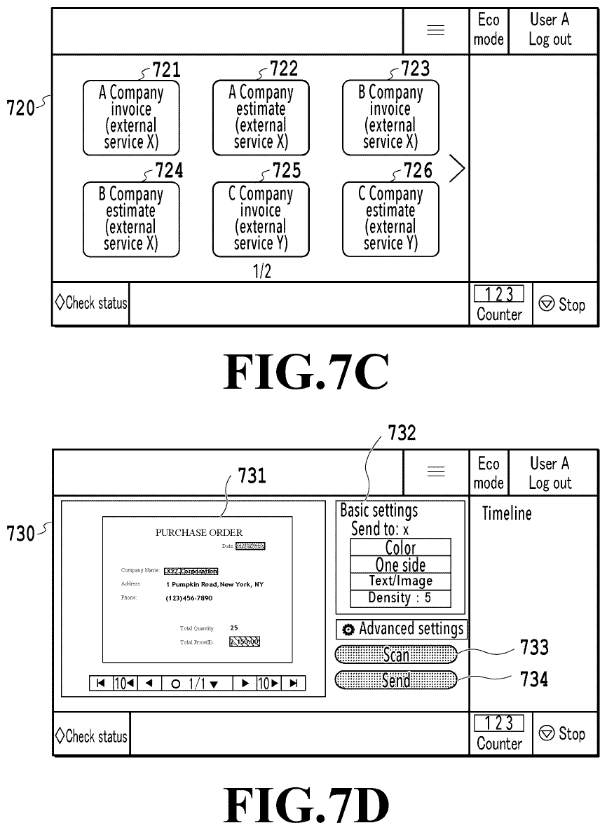

The present embodiment will now be described using FIGS. 7A to 12B.

### Display Screens

FIGS. 7A to 7D are diagrams describing an example of a series of screens up to scanning of a marked form with the MFP terminal 111 with the four screens in FIGS. 7A to 7D. To simplify the description, inputs from the user and outputs from screens presented to the user by the MFP terminal 111 are assumed to be operations performed on the operation apparatus 207, such as a touch panel, for example, controlled by the display control unit 313 through a user I/F.

### Login Screen

FIG. 7A is a diagram illustrating a login screen presented to the user in response to activation of the login application 322. A login screen 700 is displayed on the MFP terminal 111 by the display control unit 313 of the MFP terminal 111. The login screen 700 has a user name input field 701, a password input field 702, and a login button 703.

The user name input field 701 is an input field or control necessary for a login which is presented to the user. The password input field 702 is an input field for a password required for the user to log in. The login button 703 is a button that accepts a press by a user operation for login using the user name input in the user name input field 701 and the password input in the password input field 702. The login application 322 executes a login in response to receiving information and operations on the controls input by the user.

The login screen 700 is illustrated to be a general login form with a user name and a password, but is not limited to this. The login screen 700 may be provided in any manner, such as presenting a displayed field in such a way that it can be changed or switched to a control that prompts the user to input an ID or a PIN code or touch a card, and accepting an operation complying with the corresponding method to execute a login.

### Menu Screen

FIG. 7B is a diagram illustrating an example of a UI screen after a login displaying information for the logged-in user. A UI screen 710 has a logged-in user display region 711. The UI screen 710 is a menu screen and has a marker application icon 712, a copy icon 713, a scan icon 714, an inbox icon 715, an address book icon 716, and a setting icon 717.

The logged-in user display region 711 is also a control for performing a logout. Performing a logout terminates the login session, and the display returns to the one in FIG. 7A. Upon a successful login, a list of applications available to the logged-in user is displayed. In FIG. 7B, a marker application icon, a copy icon, a scan icon, an inbox icon, an address book icon, and a setting icon are displayed. As the marker application icon 712, a control for activating the marker application for setting processes for target regions of a marked document according to the present embodiment is displayed. The marker application is activated in response to a press on the marker application icon 712 by the user.

### UI Screen of Marker Application

FIG. 7C is a diagram illustrating an example of a UI screen of the marker application. A UI screen 720 is a screen displayed in response to activation of the marker application by a press on the marker application icon 712. The UI screen 720 is a single screen within which six shortcut buttons 721 to 726 are displayed.

The shortcut button 721 is a shortcut button with which scan settings and a transmission destination registered in the MFP terminal 111 or the scanned document processing server 121 are set in advance. As will be described later, colors and settings of form processing are additionally associated on a per-button basis. The settings are saved to the setting information management unit 344 of the scanned document processing server 121. By selecting a desired shortcut button from among the multiple shortcut buttons, a scan screen corresponding to the selected shortcut button is displayed to the user.

### Scan Screen

FIG. 7D is a UI screen 730 for displaying a scan screen. The UI screen 730 has a scan preview region 731, a basic scan setting field (hereinafter referred to as “scan settings”) 732, a scan button 733, and a send button 734.

The scan preview region 731 is a region in which a preview of a document scanned according to a user instruction is displayed.

The basic scan setting field 732 is a region in which information of the transmission destination and scan settings associated with the shortcut button 721 selected by the user is displayed in an editable manner. Note that the editing is performed on a screen (not illustrated) for changing the settings and the transmission destination or the saving format of a folder or the like.

The scan button 733 executes a scan in response to being pressed by a user operation after the user sets a document on the platen glass or the feeder. In response to being pressed by a user operation after the completion of the scan and confirmation of the scan preview region 731 and the scan settings 732, the send button 734 transmits the scanned image of the document obtained by the scan to the external server 131 through the scanned document processing server 121.

### Configuring Form Processing

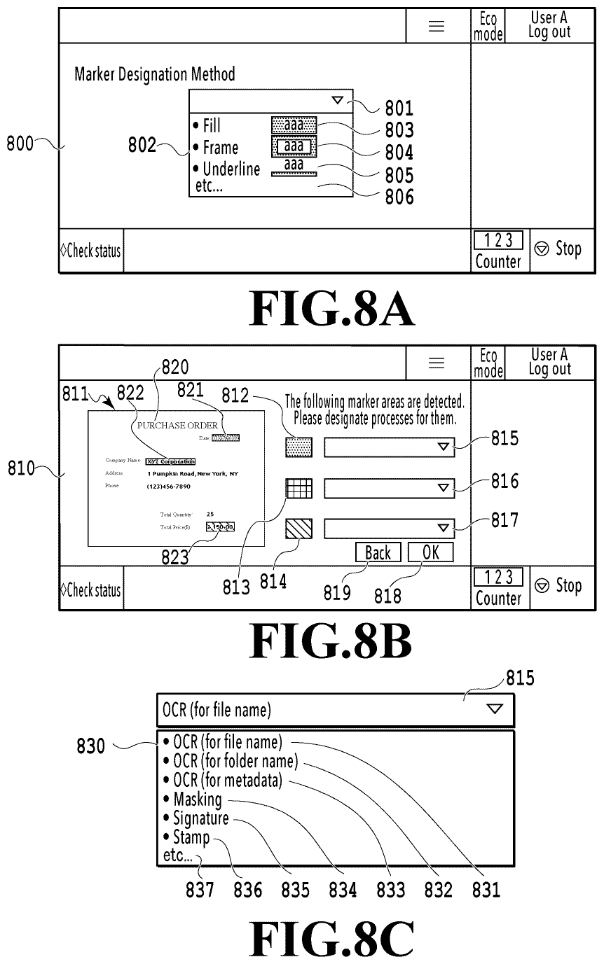

FIGS. 8A to 8C are diagrams illustrating an example of UI screens for configuring form processing in the present embodiment which associates processes with marked regions extracted from a scanned document.

### Marker Designation Method Setting Screen

FIG. 8A is a diagram illustrating a UI screen for designating the method of the marking performed by the user. A UI screen 800 has a field 801 for setting a marker designation method.

The field 801 is a control for setting a marking method. The field 801 accepts a user operation for setting the method of the marking actually performed by the user on a form from among a list of marking methods displayed on the control. The user operation can be input using a pull-down menu 802. From the pull-down menu 802, one of filling 803, framing 804, underlining 805, and etc. 806 as candidates to be selected can be selected. For the filling 803, the framing 804, and the underlining 805, the names of the respective designation methods and diagrams schematically illustrating the designation methods are displayed. Note that the display of the designation methods in the pull-down menu is not limited to this. For example, only the names of the designation methods may be displayed, or only the diagrams schematically illustrating the designation methods may be displayed. An example in which a desired designation method is selected using a pull-down menu has been described, but the display method is not limited to this. The designation methods may be presented by any display method, such as displaying another list or displaying radio buttons.

### Setting Screen for Associating Specific Processes

FIG. 8B is a diagram illustrating an example of a setting screen for associating specific processes. On the setting screen for associating specific processes, settings are configured to associate specific processes with marked regions. A UI screen 810 has a preview field 811, marker region color designation fields 812 to 814, form processing setting control 815 to 817, an OK button 818, and a back button 819.

The preview field 811 is a field which displays a preview of a document image obtained by scanning a document. The user can designate form processing for each color while viewing the preview of the document image displayed in the preview field 811. In FIG. 8B, a document image 820 obtained by scanning a marked document is displayed. The document image 820 is the same as a form image obtained by scanning the form 400 mentioned above, and has colored regions 821, 822, and 823.

The marker region color designation fields 812, 813, and 814 are controls indicating the actually detected marking colors. The detection of the marked regions is done by defining a threshold value for each parameter of a color space, such as an RGB space, an HSV space, or a HSL space, and identifying regions with color information present within that range, as described earlier.

The form processing setting controls 815 to 817 are controls for setting form processing for each color.

### Pull-Down Menu Screen

FIG. 8C is a diagram illustrating an example of a pull-down menu screen for form processing displayed by the form processing setting controls 815 to 817. Note that the form processing setting controls 815 to 817 each obtain and display information on functional components included in the form processing unit 352 of the scanned document processing server 121 to display the pull-down menu screen. FIG. 8C illustrates a state where OCR (for file name) is designated by the user.

On a pull-down menu screen 830, multiple processes listed below as candidates to be designated are displayed such that one of them can be designated. The candidates to be designated include OCR (for file name) 831, OCR (for folder name) 832, OCR (for metadata) 833, masking 834, signature 835, stamp 836, and etc. 837.

Note that the pull-down menu screen is not limited to the illustrated example of FIG. 8C. A list of image processing functions held by the MFP terminal 111 as described earlier and of image processing functions held by external image processing systems may be obtained, and that list may be displayed. For example, annotation may be designatable. In a case where annotation is designated, information on the original image and a note to be provided to the corresponding region is passed to a component with an annotation function to provide the note to the region and the note will be used as a parameter of a request when the scanned document is saved to the external server 131.

The OK button 818 saves the settings designated on the UI screen 810 in response to being pressed by a user operation. The back button 819 cancels the settings on the UI screen 810 and switches the UI screen 810 to the display screen displayed before it in response to being pressed by a user operation.

### Form Processing Setting Control

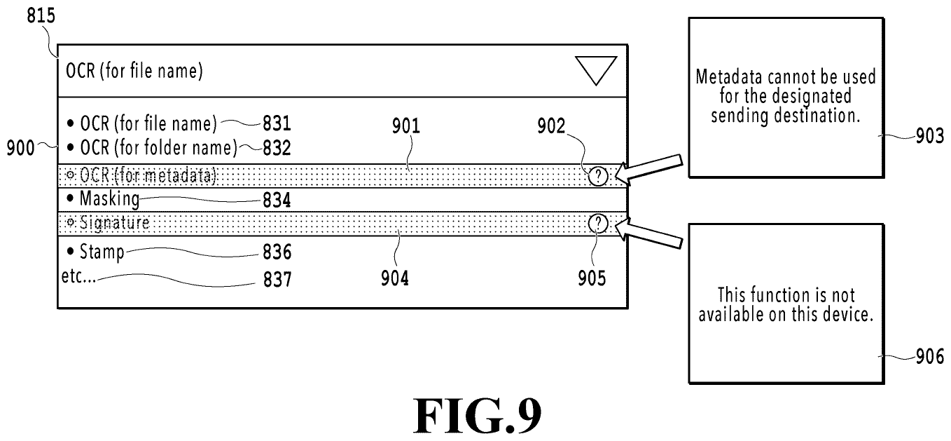

FIG. 9 is a diagram illustrating another example of the form processing setting control 815.

It is assumed that the form processing setting control 815 is basically configured to hide unexecutable form processing. Here, in a case of using, for example, a transmission destination or device different from the one that have been normally used, it may be impossible to execute the form processing that have been normally executed. In such a case, it will be difficult for the user to specify the cause if that form processing is simply hidden. To address this, a pull-down menu screen 900 taking into consideration of that case may be displayed.

On the pull-down menu screen 900, OCR (for file name) 831, OCR (for folder name) 832, masking 834, stamp 836, and etc. 837 are executable types of form processing and are displayed in an active state. In this way, the user can designate one of the OCR (for folder name) 832, the masking 834, the stamp 836, or the etc. 837.

On the pull-down menu screen 900, the types of form processing that are unexecutable by the MFP terminal 111, the scanned document processing server 121, and the external server 131 are displayed in an inactive state and cannot be designated by the user. In FIG. 9, OCR (for metadata) 901 and signature 904 are unexecutable types of form processing, and are displayed in an inactive state and cannot be designated by the user. The pull-down menu screen 900 displays help controls 902 and 905. In response a user operation, such as hovering or clicking, on the help controls 902 and 905, hints indicating why the processes are not available are presented to the user by controls 903 and 906, respectively. The controls 903 and 906 are assumed to be tooltips but a display method using a dialogue, a banner, or the like may be employed. Examples of the reason why the function is not available include reasons that are dependent on the transmission destination, such as metadata, the folder structure, forbidden characters, and connection information. Other examples include reasons that are dependent on licenses, authorities, and the like associated with device functions, devices, or the user, and reasons that are dependent on the marking method or the color making it impossible to execute the function.

### UI Screen Display Control Process

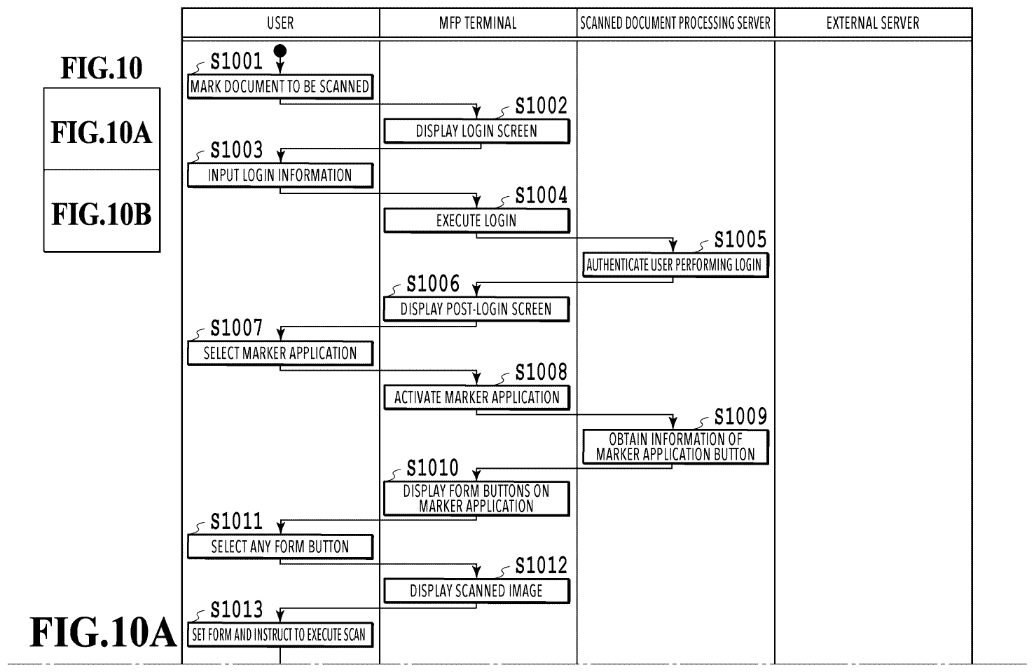

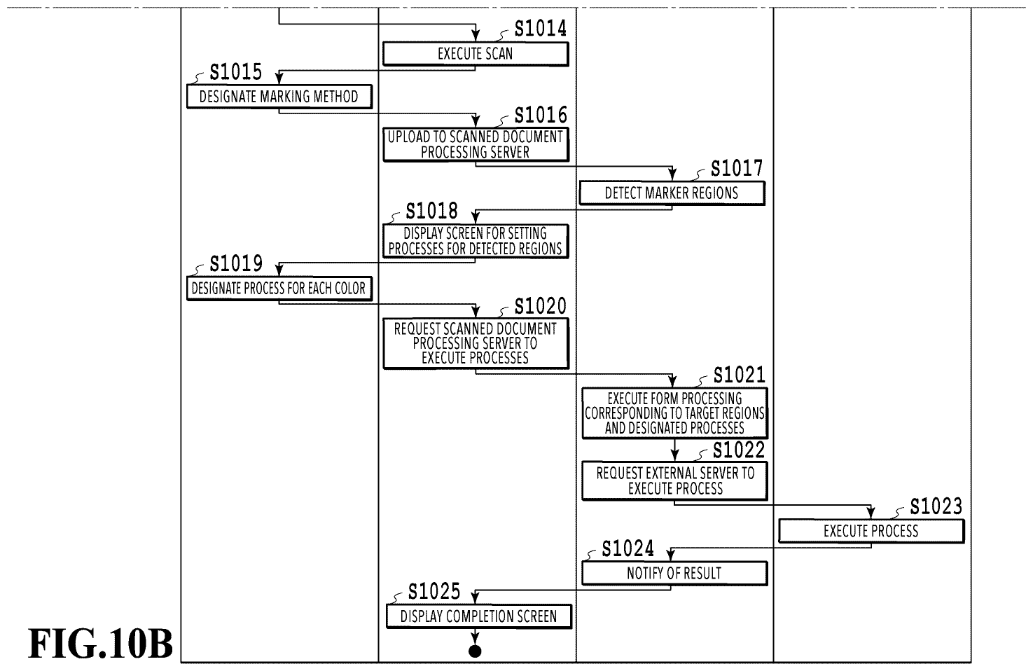

FIGS. 10A and 10B are flowcharts illustrating a flow of a UI screen display control process according to the present embodiment. Note that the process illustrated in FIGS. 10A and 10B uses the screens described using FIGS. 7A to 9.

In S1001, the user marks a form (document) to be scanned with marker pens, such as highlighters. Note that the user performs the marking operation with the marker pens while distinguishing the processes to be associated with markings by the marker colors.

In S1002, the user starts a device operation, and the login application 322 of the MFP terminal 111 displays a login screen to the user. Note that, as the login screen, the login screen 700 illustrated in FIG. 7A is displayed, for example.

In S1003, the user inputs login information into the login screen displayed on the operation apparatus 207 of the MFP terminal 111. Specifically, on the login screen, the user performs a user operation of inputting a user ID and a password into predetermined input fields and pressing the login button.

In S1004, based on the login information input by the user, the login application 322 of the MFP terminal 111 issues an authentication request to the external system communication unit 354 of the scanned document processing server 121 through the external system communication unit 312.

In S1005, the scanned document processing server 121 analyzes the request and verifies whether the login information transmitted in S1004 and information on the user managed by the setting information management unit 344 match each other.

In S1006, if the verification is successful, the scanned document processing server 121 returns a successful response to the MFP terminal 111, and the MFP terminal 111 presents a post-login screen to the user. Note that, as the post-login screen, the UI screen 710 illustrated in FIG. 7B is displayed, for example.

In S1007, the user selects the marker application icon 712, which activates the marker application, from the list of available functions on the post-login screen displayed on the MFP terminal 111.

In S1008, in response to the selection of the marker application icon 712 in S1007, the MFP terminal 111 activates the marker application 323.

In S1009, after the activation of the marker application 323, the scanned document processing server 121 obtains the scan setting information stored in association with the user in the setting information management unit 344 of the scanned document processing server 121 based on information on the logged-in user.

In S1010, the MFP terminal 111 lists the obtained setting information in the form of shortcut buttons on the display of the marker application 323. Note that, as the UI screen of the marker application, the UI screen 720 illustrated in FIG. 7C is displayed, for example.

In S1011, the user selects a shortcut button according to the form to be used and the contents to be processed. For example, the user selects the shortcut button 721 on the UI screen 720.

In S1012, the MFP terminal 111 displays a scan screen in which the transmission destination and scan settings corresponding to the selected shortcut button are reflected. Note that, as the scan screen, the UI screen 730 illustrated in FIG. 7D is displayed, for example.

In S1013, the user sets the marked form on the platen glass or the feeder, changes the scan settings as appropriate, and issues an instruction to execute a scan.

In S1014, the scan execution unit 315 of the MFP terminal 111 executes a scan process on the set form based on the settings configured on the scan screen.

In S1015, the user sets the method of the marking performed on the scanned form. For example, the user sets the marking method on the UI screen 800 illustrated in FIG. 8A. Note that the marking method is set after the scan process, but the timing is not limited to this. The marking method may be set before the scan process is performed as long as it is before the upload to be described next.

In S1016, the MFP terminal 111 uploads the set marking method and the scanned image data of the document obtained by the scan process to the scanned document processing server 121.

In S1017, the scanned document processing server 121 stores the uploaded scanned image data of the document in the scanned document storage unit 342, stacks it in the scanned document job queue 343, and detects the marker regions with the form processing unit 352.

In S1018, the MFP terminal 111 returns process result information including color information and coordinates of the detected regions, information on the character strings in the regions, a list of form processing functions supported by the form processing unit 352 to the marker application 323 as a response. The marker application 323 displays a screen for setting form processing for each detected color region along with region information detected by the device based on the result and the scanned image data. As the setting screen, the UI screen 810 illustrated in FIG. 8B is displayed, for example.

In S1019, the user designates one option from among multiple options for form processing to be executed for each color region.

In S1020, in response to a user operation, the marker application 323 of the MFP terminal 111 requests the scanned document processing server 121 to execute the designated types of form processing on the color regions.

In S1021, the scanned document processing server 121 executes processing corresponding to the requested target regions of the document and the designated processes with functional components of the form processing unit 352.

In S1022, after completing the form processing on the scanned document, the scanned document processing server 121 generates request parameters based on information such as the output scanned image data subjected to the form processing, the character strings obtained by the form processing, and the like. Then, the scanned document processing server 121 requests the external server 131, which is the final storage destination, to execute a process. Since the external server 131 is assumed to be a cloud storage, the external server 131 executes a storage request. The external server 131 may also collaborate with a workflow of a different task to execute a request to perform a process of executing the workflow, for example.

In S1023, the data processing unit 365 of the external server 131 executes the process based on the contents of the request. Then, after completing the process, the data processing unit 365 returns the process result to the scanned document processing server 121.

In S1024, the scanned document processing server 121 notifies the marker application 323 of the MFP terminal 111 of the process result received from the external server 131.

In S1025, the marker application 323 of the MFP terminal 111 displays a completion screen to indicate the completion of the processing to the user. The completion screen (not illustrated) may be a dedicated screen prepared in advance or provided by any means or method, such as a notification in the form of a dialogue, a banner, or the like, a notification via email, or transitioning to the UI screen 720 illustrated in FIG. 7C, which is a home screen, for example. Transitioning to the UI screen 710 illustrated in FIG. 7B may be another option.

The above has described a preview display method in which marked regions are detected from a form marked by a user, and processes to be performed on those regions are designated on a device. This reduces the burden on the user for the marking and makes it easy to configure settings for associating processes with the marked regions.

### UI Screen Display Control Process

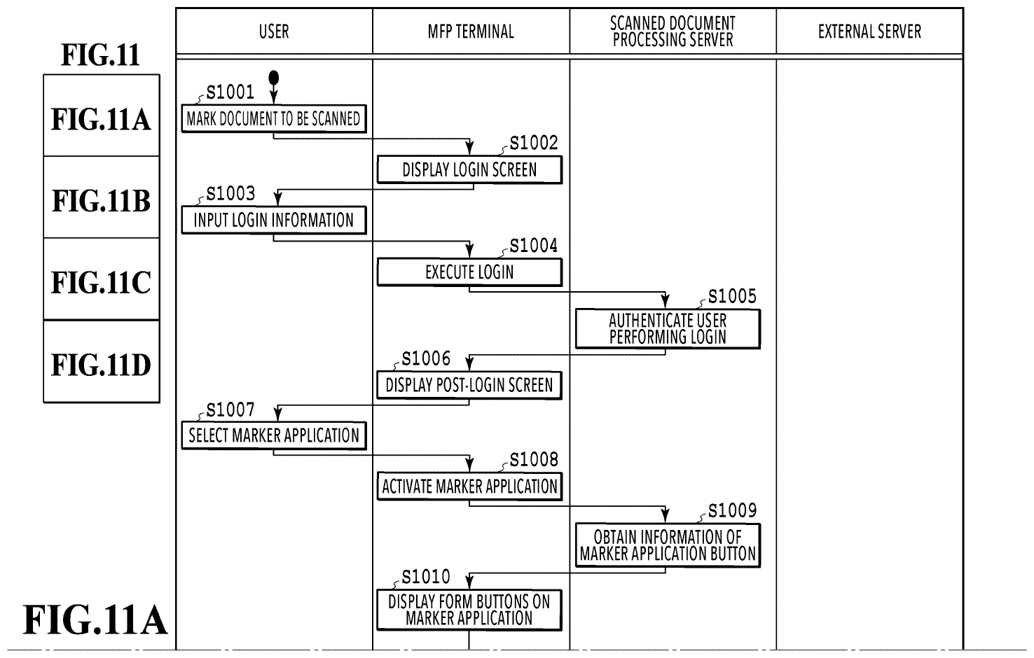

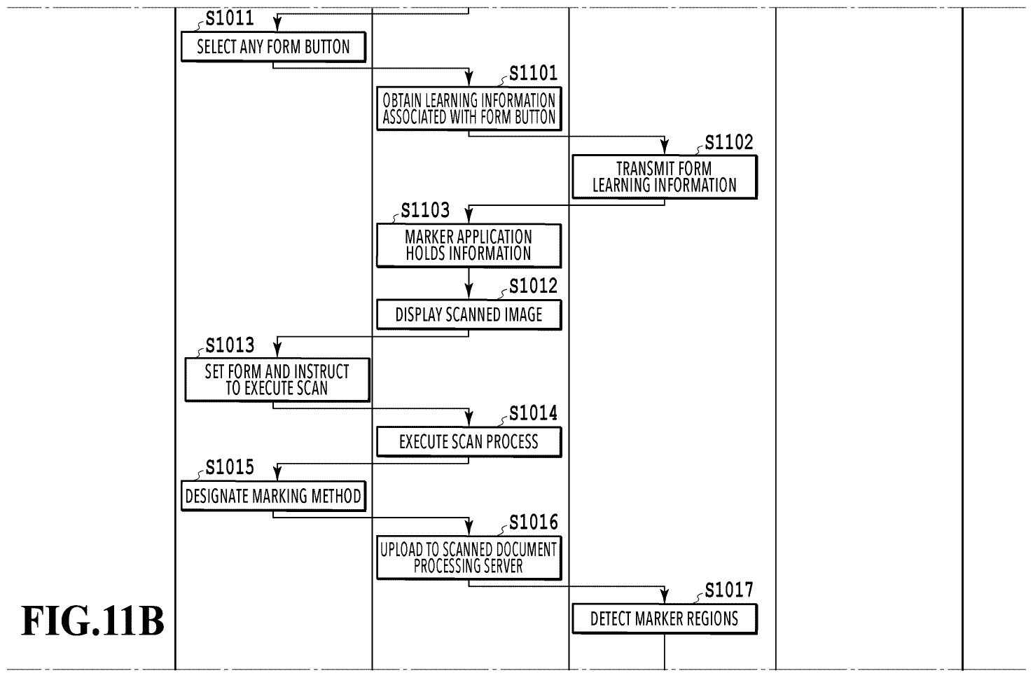

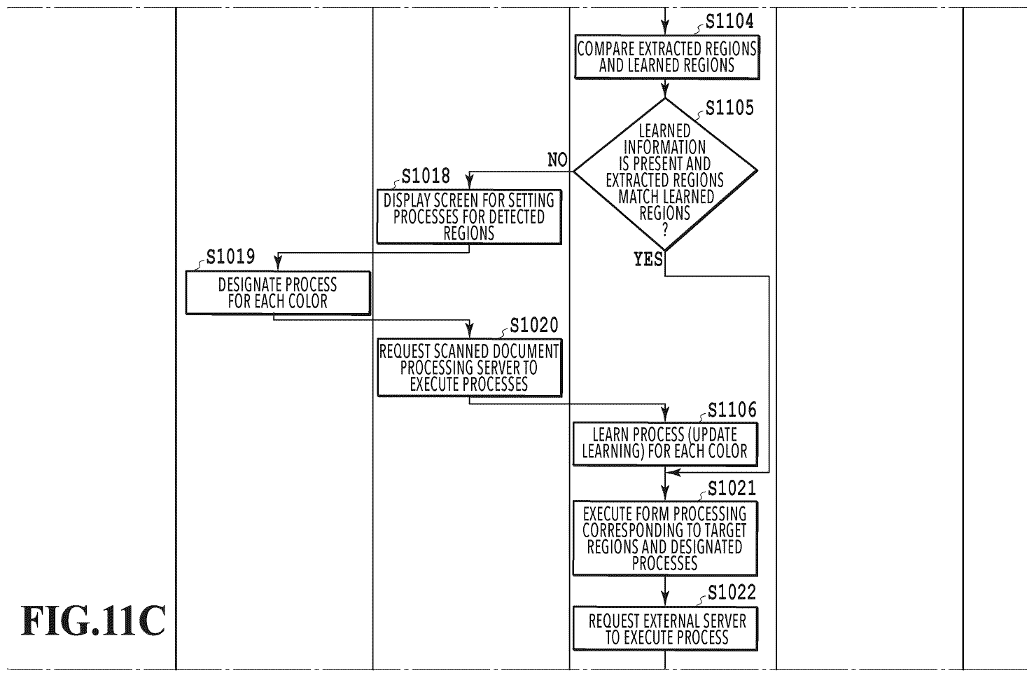

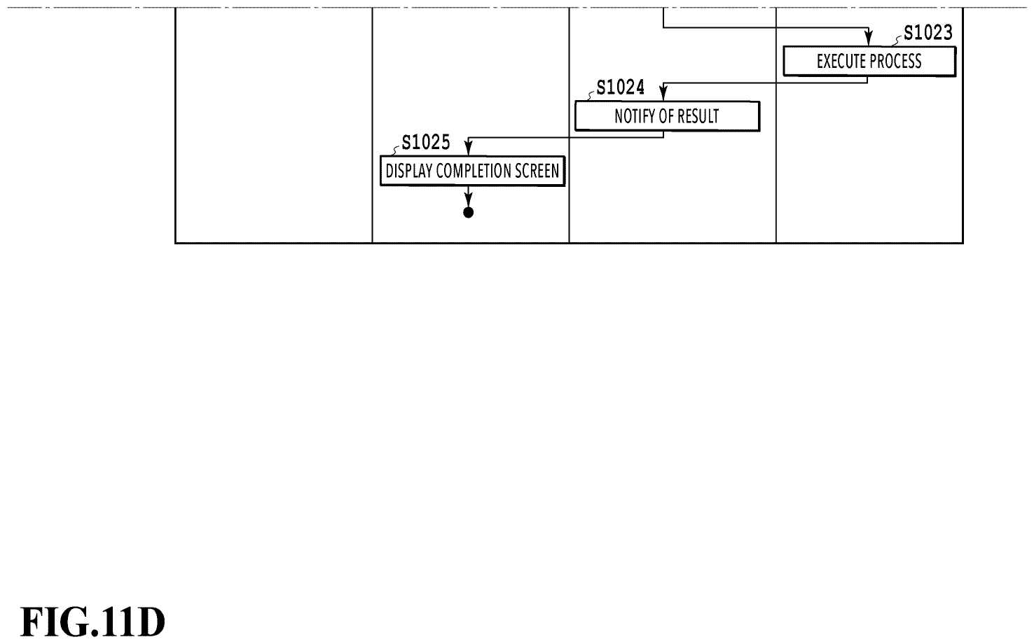

FIGS. 11A to 11D are flowcharts illustrating a modification of the flow of the UI screen display control process representing the process illustrated in FIGS. 10A and 10B to which learning is added. FIGS. 11A to 11D illustrate a method that makes simpler the preview operation which the user performs on the device by learning the user's marking method, marked regions, and the types of form processing associated with the regions. A specific effect of the learning is that, in a case where learning information is present, a screen is displayed in a state where the settings configured in FIGS. 8A, 8B and 8C, S1015, and S1018 are already reflected or the display is skipped, allowing for simpler setting operations. The difference from FIGS. 10A and 10B will now be mainly described.

In S1101, after the user selects any form button, the marker application 323 of the MFP terminal 111 inquires of the scanned document processing server 121 whether learning information associated with that form (shortcut button) is present.

In S1102, the scanned document processing server 121 analyzes the request and confirms whether learning information associated with the user and the form for which the request was made is present in learning information held by the setting information management unit 344. The confirmation result is returned to the marker application 323.

In S1103, the marker application 323 of the MFP terminal 111 holds the received result therein in order to reflect the learning information in a process to be described later or switch the flow.

Then, in S1012 to S1017, the processes with the contents described in FIGS. 10A and 10B are performed to upload the marked scanned image data and a processing request to the scanned document processing server 121 and extract the marked regions.

As a supplementary note regarding the learning flow, in this uploading process, information, such as an ID for example, that uniquely identifies the form button selected by the user, is included in the request and associated with the form shortcut button selected on the device and the learning information.

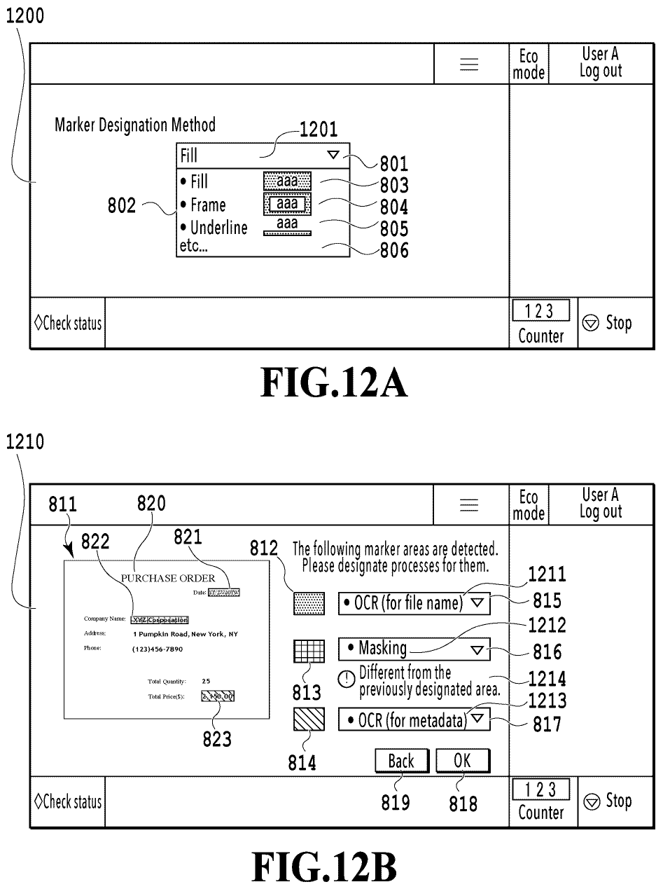

Also, in S1015, the learning information may be used to display a UI screen 1200 illustrated in FIG. 12A, which is a screen for setting a marker designation method, in a state where information reflecting the learning information as the marker designation method, e.g., a state where filling 1201 is selected in the example of FIG. 12A, is displayed.

In S1104, the form processing unit 352 of the scanned document processing server 121 compares the extracted marked regions with the learned extracted regions and their colors to determine if they match. In S1105, the form processing unit 352 of the scanned document processing server 121 determines whether learned information is present and the extracted marked regions match the learned extracted region and their colors.

If learned information is present and the result of the comparison indicates that the extracted marked regions match the learned extracted region and their colors (YES in S1105), the steps S1018 to S1020 are omitted, and the processing proceeds to S1021. As a result, a learned process previously set by the user, i.e., an expected process, is executed as is. On the other hand, if no learned information is present or the result of the comparison indicates that the extracted marked regions do not match the learned extracted region and their colors (NO in S1105), the processing proceeds to S1018.

In S1018, the MFP terminal displays a screen for setting processes for the detected regions. Then, in S1019, the user designates the extracted color regions and form processing to be performed on each region.

Here, in S1104, the extracted marked regions may not match the learned extracted regions and their colors but may partly match them. In this case, part of the learned process settings for the region or regions of the corresponding color or colors can be suggested. This makes the setting operations simpler. Details of this will be described later using FIGS. 12A and 12B.

In S1018, a setting screen in which the learning information is reflected may be displayed. Specifically, a setting screen may be displayed in a state where specific processes associated with the colors, e.g., OCR (for folder name) 1211, masking 1212, and OCR (for metadata) 1213 on the UI screen 1210 illustrated FIG. 12B, are already selected.

If the extracted marked regions do not match the learned information or no learned information is present, then in S1106, the marker application 323 of the scanned document processing server 121 learns or updates the learned information with the setting contents after the setting operation is completed. Here, in consideration of a false detection, a configuration that allows the user to select whether to update the learned information or not as appropriate may be employed. The learned information may be, for example, a trained model trained to receive a document image obtained by reading a document as an input and outputs regions detected from the document image and processes set for the detected regions.

Thereafter, the processing proceeds to the processes of S1021 and a subsequent step to request a process, such as saving the document subjected to the form processing with the contents designated by the user to the designated external server 131.

Setting Screens for Form Processing (with Learned Information)

Setting screens for form processing in a case where learned information is present will now be described using FIGS. 12A and 12B.

### Marker Designation Method Setting Screen

FIG. 12A is a diagram illustrating a screen for setting a marker designation method. Note that the difference from the marker designation method setting screen illustrated in FIG. 8A will mainly be described.

The UI screen 1200 is a setting screen for form processing in a case where setting information associated with a user and a form button is present as learned information, and is displayed in a state where filling 1201 representing a learned content is reflected in the field 801 for setting a marker designation method.

### Setting Screen for Associating Specific Processes

FIG. 12B is a diagram illustrating an example of a setting screen for associating specific processes. The difference from the setting screen for associating specific processes illustrated in FIG. 8B will mainly be described.

A UI screen 1210 is a setting screen for associating specific processes in a case where setting information associated with a user and a form button is present as learned information, and is displayed in a state where a learned content is reflected in each of the form processing setting controls 815 to 817. The OCR (for folder name) 1211 is reflected and displayed in the form processing setting control 815. The masking 1212 is reflected and displayed in the form processing setting control 816. The OCR (for metadata) 1213 is reflected and displayed in the form processing setting control 817. Also, in a case where a region different from the previously learned contents and a designation method different from the previous occasions is performed, means for displaying an error message 1214 under the corresponding control 816 to prompt the user to confirm the processing result may be used.

As described above, in the present embodiment, a preview UI for easily configuring form processing to be performed on a marked form is provided. This reduces the burden on the user for the marking and makes it easy to configure settings for associating processes with the marked regions.

With the technique of Japanese Patent Laid-Open No. 2022-140208 described above, pieces of information indicating predefined processes associated with colors that may be used for marking are stored in advance and, in a situation where the user performs marking, the user needs to follow the stored information to change the marker pen color to use, which is troublesome. In particular, increasing the number of types of colors that may be used for marking increases the number of combinations of a color and a process, which may impose a greater burden on the user for remembering the combinations and changing the combination to use.

According to the present embodiment, the burden on the user for the marking is reduced and settings to be associated with the marked regions are easily configured.

### OTHER EMBODIMENTS

The present disclosure is not limited to the above-described embodiment, and may be modified in various ways and features of the above-described embodiment may be combined as appropriate.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present embodiment, it is possible to reduce the burden on a user for marking and make it easy to configure settings to be associated with marked regions.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-152248, filed Sep. 4, 2024, which is hereby incorporated by reference herein in its entirety.

What is claimed is:

1. An information processing apparatus comprising:
at least one memory that stores instructions; and
at least one processor that executes the instructions to:
detect, from a document image obtained by reading a marked document, a marked region;
display a first setting screen for setting a process to be associated with the detected marked region based on designation by a user; and
execute the process set on the first setting screen on the detected marked region.

2. The information processing apparatus according to claim 1, wherein
the displaying involves displaying a second setting screen for setting a marking method for the marked region to be subjected to the detection based on designation by the user, and
the detection involves detecting a marked region by the marking method set on the second setting screen.

3. The information processing apparatus according to claim 2, wherein the marking method is one of filling which colors an entirety of a predetermined region, framing which colors a periphery of the predetermined region, or underlining which colors an underside of the predetermined region.

4. The information processing apparatus according to claim 1, wherein
the detection involves detecting a marked region for each of colors,
the displaying involves displaying the first setting screen for setting a process to be associated with the detected marked region for each of the colors based on designation by the user; and
the execution involves executing the process set on the first setting screen for each of the colors on the marked region detected for the corresponding color.

5. The information processing apparatus according to claim 1, wherein
the displaying involves displaying the first setting screen such that
a process of performing a character recognition process on the marked region and setting an obtained process result as a file name of the document image,
a process of performing a character recognition process on the marked region and setting an obtained process result as a name of a folder for storing the document image,
a process of masking the marked region,
a process of performing a character recognition process on the marked region and using an obtained process result as a signature, or
a process of performing a character recognition process on the marked region and using an obtained process result as a stamp
is designatable as the process.

6. The information processing apparatus according to claim 5, wherein
the displaying involves displaying a process which is unexecutable by the information processing apparatus in an undesignatable state among a plurality of processes being candidates to be designated.

7. The information processing apparatus according to claim 6, wherein
the displaying involves, in a case where a process which is unexecutable by the information processing apparatus is present, displaying information on a reason why the unexecutable process is unexecutable.

8. The information processing apparatus according to claim 1, wherein
the at least one processor further executes the instruction to save the document image and the process set for the detected marked region in the document image in association with each other.

9. The information processing apparatus according to claim 1, wherein,
the execution involves, in a case where a trained model is present which is trained to receive the document image as an input and outputs the marked region detected from the document image and a process set for the detected marked region, executing the process based on the marked region detected by the detection and the marked region designated by the trained model.

10. The information processing apparatus according to claim 9, wherein
the execution involves, in the case where the trained model which has associated the process with a region matching the marked region detected by the detection is present, executing the process associated with the region designated by the trained model.

11. The information processing apparatus according to claim 9, wherein
the execution involves, in a case where the trained model which has associated the process with a region matching the marked region detected by the detection is not present, executing the process set on the first setting screen on the marked region detected from the document image.

12. The information processing apparatus according to claim 11, wherein
the at least one processor further executes the instruction to generate a trained model which has associated the process with the marked region detected by the detection.

13. An information processing method comprising:
detecting, from a document image obtained by reading a marked document, a marked region;
displaying a first setting screen for setting a process to be associated with the detected marked region based on designation by a user; and
executing the process set on the first setting screen on the detected marked region.

14. A non-transitory computer readable storage medium storing a program for causing a computer to perform an information processing method, the information processing method comprising:
detecting, from a document image obtained by reading a marked document, a marked region;
displaying a first setting screen for setting a process to be associated with the detected marked region based on designation by a user; and
executing the process set on the first setting screen on the detected marked region.
